(19) United States
(12) Patent Application Publication
(10) Pub. No.: US 2006/0207424 A1
(43) Pub. Date: Sep. 21, 2006

(54) Piston and method of manufacture

(75) Inventor: Randall R. Gaiser, Chelsea, MI (US)

Correspondence Address: DICKINSON WRIGHT PLLC, 38525 WOODWARD AVENUE, SUITE 2000, BLOOMFIELD HILLS, MI, 48304-2970, US

(73) Assignee: Federal--Mogul World Wide, Inc., Southfield, MI (US)

(21) Appl. No.: 11/083,723

(22) Filed: Mar. 18, 2005

(51) Int. Cl. F16J 1/04

(52) U.S. Cl. 92/222

(57) ABSTRACT

A piston particularly adapted for heavy-duty diesel engine applications is fabricated from a separate head portion and base portion having circumferentially extending joining surfaces that are heated prior to bonding to an elevated temperature sufficient to enable bonding of the joining surfaces, and thereafter the joining surfaces brought into contact with one another and twisted to attain a permanent metallurgical weld at the interface of the joining surfaces. The head portion has an eccentric combustion bowl and crown. The joined head portion and base portion together form a monobloc piston having a closed gallery which is adapted to receive a cooling fluid, such as oil. The combustion bowl has a substantially uniform bowl sidewall thickness. The piston and method are particularly adopted for use with steel alloys and other high temperature metal alloys.

### BACKGROUND OF THE INVENTION

1. Technical Field

This invention is related generally to pistons and methods of manufacturing pistons. More particularly, it is related to monobloc pistons having an offset or eccentric combustion bowl and a closed cooling gallery, and methods of their manufacture.

2. Related Art

In heavy-duty piston applications, such as those used in industrial diesel engines, various methods are known for bonding separately formed portions of a piston in order to yield a piston monobloc structure. In a monobloc piston the crown, sidewall including ring grooves and skirt are either formed together or joined together to form a monolithic piston structure. One joining process used to form heavy-duty monobloc pistons is friction welding in which one portion of the piston is rotated at high speed while pressed against the other portion, with the resulting frictional energy generating sufficient heat to metallurgically bond the portions together. Other techniques include resistance welding, induction welding and the like in which, after the portions are brought into contact with one another, an energy flux is introduced across their joining surfaces which causes them to be heated sufficiently to join the surfaces to one another.

U.S. Pat. No. 5,150,517 is an example of friction welding, whereas U.S. Pat. No. 6,291,806 is an example of typical induction heating wherein the induction coils are presented to the sides of the contacting joining surfaces to induce heating at the interface. Such side presentation of the induction coils has a tendency to heat the regions of the joining surfaces near the edges of the material adjacent the induction coils at a faster rate than those regions further from the coils, thus producing a variation in the heat flow and heat affected zone in the area of the material adjacent the interface. In a demanding, highly loaded application, such as a monobloc piston for a diesel engine, it would be desirable to provide a weld joint that is uniform in its heat affected zone across the interface so as to minimize any variation in strength and integrity of the material.

U.S. Pat. No. 6,155,157 discloses a piston having first and second portions which are joined across two radially spaced sets of joining surfaces by means of friction welding. It will be appreciated that such an architecture presents a challenge to joining the portions by traditional circumferential induction welding, since access to the inner set of forming surfaces is limited and with respect to the positioning of an induction coil next to the mated joining surfaces.

Outside of the field of heavy-duty pistons, induction heating has been used to join simple structures, such as butt-welding metal tubes that carry petroleum products. Such tubing is a simple, single-walled cylindrical structure having flat, planar end faces. To join one end face to another, an induction coil is introduced between and proximate to the end faces, and the end faces are heated to an elevated temperature, after which the coil is withdrawn and the end faces are brought into engagement with one another to achieve a weld joint. Preferably, once the surfaces are brought into contact, they are twisted a small amount (a few degrees) to attain more intimate union of the weld surfaces.

Related, commonly owned, co-pending U.S. patent application Ser. No. 10/701,274 filed on Nov. 4, 2003, which is hereby incorporated herein by reference in its entirety, describes a method of making a piston, which according to a first aspect of the invention includes fabricating first and second parts of the piston each having at least two joining surfaces. The portions are supported with the joining surfaces in spaced relation to one another. While spaced, the joining surfaces are heated to an elevated temperature and thereafter the heat is discontinued and the joining surfaces are brought into contact with one another to form a metallurgical bond across the joining surfaces. While this method has been found to be very desirable for joining monobloc pistons, it use has been limited to generally axisymmetric pistons. This method has not been used to join piston elements which are non-axisymmetric, such as those having eccentric combustion bowls which are offset from the piston axis and which are also adapted to maintain a uniform sidewall thickness in the bowl, including in what may be described as the undercrown portion of the bowl sidewall, which is typically in the center portion of the bowl and which may also be raised or extend upwardly within this portion of the bowl. This joining method has not been used for such piston designs because according to this method, the respective joining surfaces require a concentric relationship with respect to the longitudinal axis of the piston, while the eccentric placement of the bowl and raised portion thereof with respect to the piston axis makes it difficult to produce a substantially uniform sidewall thickness, particularly when using conventional machining and other material removal methods for forming the first and second parts. This spatial relationship also relates to and affects the formation of an oil gallery under the crown, because offsetting the combustion bowl while seeking to maintain a substantially uniform sidewall thickness requires that the oil gallery have an inner surface that is non-axisymmetric with respect to the piston axis, and an outer surface that is substantially symmetric about the piston axis in order to maintain a substantially uniform outer wall thickness of the piston. Such gallery shapes and sidewall thickness are difficult to produce using conventional machining of forged or cast part blanks, particularly if narrow sidewall geometry is desired to improve cooling efficiency. This difficulty of forming the gallery is further exacerbated if the gallery is a closed gallery, because of the need to form portions of the non-axisymmetric gallery in both parts, and further, to join the parts while maintaining their corresponding axial and radial alignment.

US Pat. Nos. 5,245,752 and 5,588,351 to Lippai et al. describe a piston having a non-uniform, open gallery associated with an eccentric combustion bowl, and a method for forming the gallery and joining it to a base, but do not describe a piston having an eccentric bowl and a closed gallery, or a method of forming or joining a piston having a closed gallery and an eccentric bowl.

Increased piston performance requirements and other factors make the improvement of monobloc pistons very desirable, including the development of monobloc pistons having eccentric combustion bowls, closed cooling galleries and substantially uniform sidewall thicknesses within the combustion bowls, and also including improved methods of manufacture which enable the manufacture of improved monobloc piston designs.

### SUMMARY OF THE INVENTION

The present invention includes a monobloc piston having an eccentric combustion bowl, a closed cooling gallery and a substantially uniform sidewall thickness within the combustion bowl, as well as a method of making the same.

A piston according to a first aspect of the invention includes a head portion having a head longitudinal axis, a recessed combustion bowl having a bowl axis which is offset from the head portion axis, a head gallery recess disposed within a bottom surface of the head portion and about the combustion bowl which gallery recess defines a substantial uniform thickness of the bowl side wall, and a cylindrical outer head joining portion and a cylindrical inner head joining portion which are concentric with the head axis. The piston also includes a base portion having a base longitudinal axis, a base gallery recess disposed within a top surface of the base portion and which is opposite the head gallery recess and together therewith comprises a closed cooling gallery, a cylindrical outer base joining portion and a cylindrical inner base joining portion. The piston also includes an outer weld joining the outer head joining portion and the outer base joining portion and an inner weld joining the inner head joining portion and the inner base joining portion.

According to a second aspect of the invention, the invention includes a method of making a piston of the type described above by fabricating a head portion and a base portion having the respective cylindrical joining surfaces. The head and base portions are supported with the joining surfaces in spaced relation to one another. While spaced, the joining surfaces are heated to an elevated temperature and thereafter the heat is discontinued and the joining surfaces are brought into contact with one another to form a metallurgical bond across the joining surfaces.

According to a third aspect of the invention, a piston is provided having an eccentric combustion bowl and closed oil gallery, and also having first and second portions with mating joining surfaces joined by an induction weld joint and having a heat affected zone which is uniform across the joint. The weld joint may also comprise a necked-down section of the head and base joining portions.

The invention has the advantage of providing a simple, low-cost method for welding the head and base portions to form a monobloc piston having a closed oil gallery and an eccentric combustion bowl having a substantially uniform bowl sidewall thickness.

### BRIEF DESCRIPTION OF THE DRAWINGS

These and other features and advantages of the present invention will become more readily appreciated when considered in connection with the following detailed description and appended drawings, wherein:

FIG. 1 is a perspective view of the head portion and base portion of a piston of the present invention prior to welding;

FIG. 2 is a cross-sectional view through the head and base portions of the piston of FIG. 1 at line 2-2;

FIG. 3 is a cross-sectional view through the head portion of the piston of FIGS. 1 and 2 at line 3-3;

FIG. 4 is a perspective view of the head and base portions of FIG. 1 after welding;

FIG. 5 is a perspective view of the final machined piston;

FIG. 6 is a cross-sectional view taken along line 6-6 of FIG. 5;

FIG. 7 is an enlarged fragmentary sectional view showing the joining portions of the head and base having a necked-down region; and

FIGS. 8 A-L are sectional views of several embodiments of differing bowl crown/combustion bowl combinations as they might appear as viewed from a piston of FIG. 5 as viewed generally along line 8-8 of FIG. 6.

### DETAILED DESCRIPTION OF THE PREFERRED EMBODIMENT

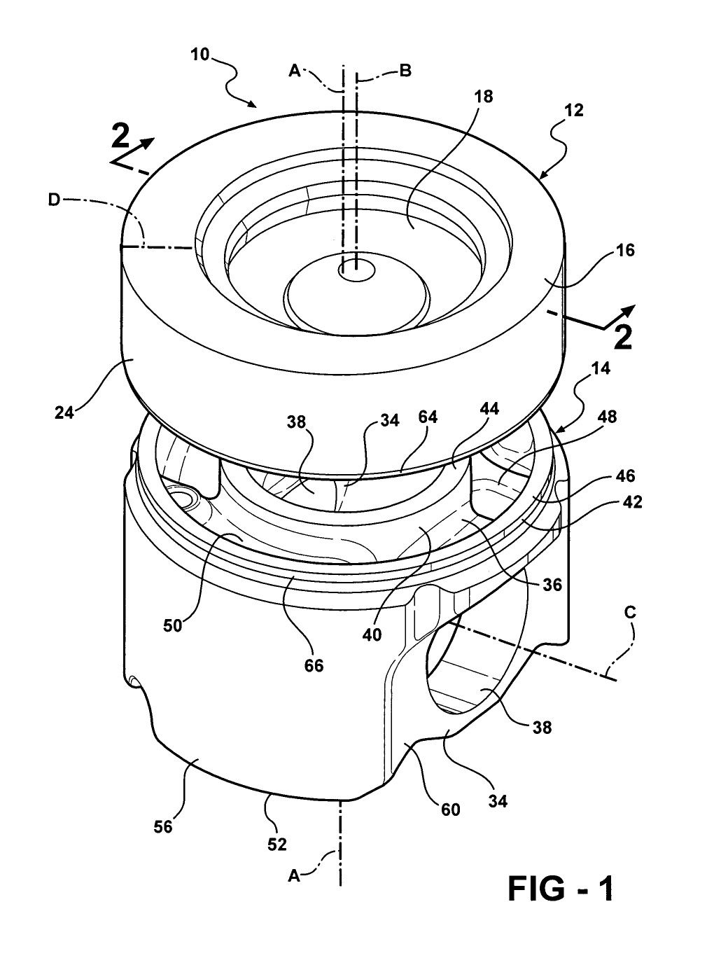

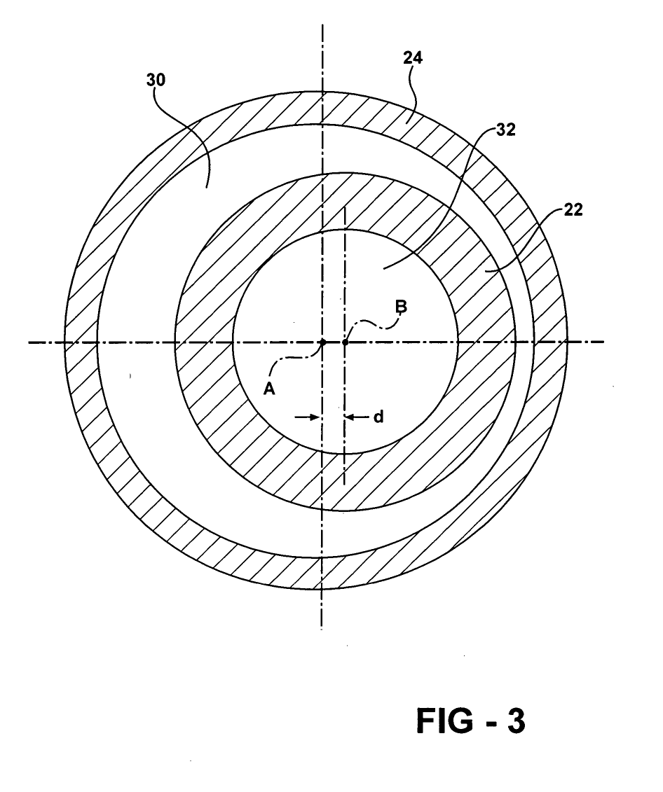

Referring to FIGS. 1-8, a monobloc piston constructed according to a presently preferred embodiment of the invention is shown generally at 10 in the drawings and is fabricated of at least two parts which are formed separately from one another in a manner to provide at least two sets of circumferentially extending mateable joining surfaces which are initially spaced apart from one another and heated to a temperature sufficient for welding the parts, after which the heating of the surfaces is terminated and the surfaces are joined to one another to affect a permanent weld between the parts.

Referring to FIGS. 1-7, in the illustrated embodiment, piston 10 includes a head portion 12 and a base portion 14. Both head portion 12 and base portion 14 are fabricated of metal, and are preferably formed from steel alloys, although the invention is not limited to these materials. As will be explained further below, the piston and method are particularly adapted for use with high temperature alloys. The head portion 12 and base portion 14 may be cast, forged, fabricated of powder metal or any other suitable fabrication process for making metal parts. The head portion 12 and base portion 14 may be fabricated using the same fabrication method or different fabrication methods as a design choice which depends upon the design requirements, cost and other factors associated with each of these parts and the finished piston. However, it is believed that casting and powder metal fabrication processes are preferred due to the part geometry associated with the eccentric bowl and desire to maintain a substantially uniform combustion bowl and bowl crown wall thickness. The alloys used for the head portion 12 and base portion 14 may be the same or different, and thus the temperature at which the first and second parts need to be heated in order to affect welding of the materials may be the same or different, depending upon the requirements of a particular application.

In the illustrated embodiment, the head portion 12 comprises an upper crown part of the piston 10, and the base portion 14 comprises a lower crown part of the piston 10 that complements the head portion 12 such that when joined, the parts 12, 14 make up the piston 10. As joined, piston 10 comprises a monobloc piston.

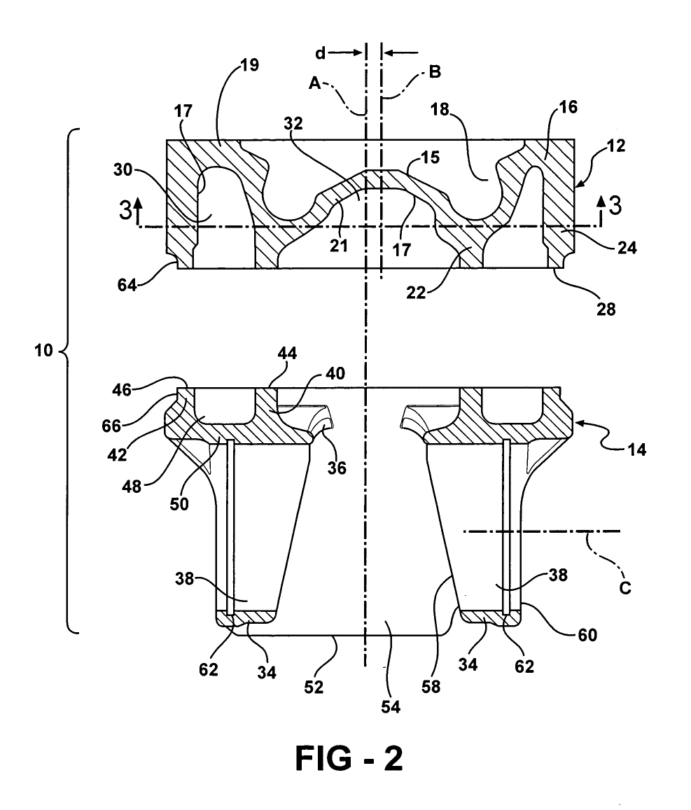

Referring to FIGS. 1 and 2, head portion 12 has an upper wall 16 formed with a combustion bowl 18 and an upper surface 15 and a lower surface 17. The combustion bowl 18 may be symmetric about a longitudinal axis B of bowl 18 as illustrated, or may be non-symmetrical, if called for by a particular application. Combustion bowl 18 is eccentric or offset with respect to longitudinal axis A of piston 10. Where combustion bowl 18 is symmetric about an axis B, the degree of eccentricity or offset may be described as the distance between axis A and axis B as by an offset spacing (d). Combustion bowl 18 and head portion 12 are formed so as to have a particular position or orientation relative to base portion 14, such that the angular location of the combustion bowl 18 relative to base portion 14 is critical to the operation of the piston 10. Combustion bowl 18 is formed with a combustion bowl sidewall 19 forming the sides of bowl 18 and bowl crown sidewall 21 forming generally the base or bottom of bowl 18.

Head portion 12 is formed with an upper inner annular wall 22 extending downwardly below the combustion bowl 18 and depending from bowl sidewall 19 and bowl crown sidewall 21, and an upper outer annular wall 24 or ring belt 24 that is spaced radially outwardly of inner annular wall 22 and depends from upper wall 16. The inner wall 22 and outer walls 24 are formed at or near their ends with inner head joining surface 26 and outer head joining surface 28. Inner and outer head joining surfaces 26, 28 are circumferentially extending and preferably continuous and formed symmetrically with respect to the piston longitudinal axis A, such that inner and outer head joining surfaces 26, 28 are concentric about axis A. While any suitable method of forming or fabricating head portion 12 may be utilized, it is preferred that head portion 12 be formed by casting or by processing (e.g. pressing and sintering) of a powder metal. It is preferred that head portion 12 comprise a high temperature alloy such as steel or alloys having an operating temperature range that is greater than steel. It is also preferred that the method utilized to form head portion 12 be adapted to provide a near-net shaped part that includes annular recess 30 and undercrown region 32 as defined by sidewalls 16, 19, 21 and 24 formed in their near-net shape. By near-net shape, it is meant that these features are formed such that significant material removal is not required to obtain their net or final shapes.

Prior to welding of head portion 12 to base portion 14, head portion 12 is preferably machined, ground, polished or otherwise treated to provide a final shape and finish to the combustion bowl 18 and inner and outer head joining surfaces 26, 28. As will be described further below, piston 10 is formed with a series of ring grooves in the outer ring belt 24, but such ring grooves are preferably machined into piston 10 following the joining of head portion 12 and base portion 14.

The base or lower crown part 14 of piston 10 is formed with a pair of pin bosses 34 extending downwardly from neck 36 and formed with a set of pin bores 38 coaxially aligned along pin bore axis C. Neck 36 is formed with lower inner annular wall 40 and lower outer annular wall 42. The lower inner and outer walls 40, 42 are formed with respective joining surfaces 44, 46 which are circumferentially extending and preferably continuous and which align and mate with the upper joining surfaces 26, 28, respectively, of the upper inner and outer walls 22, 24 of the upper crown 12. As best illustrated in FIG. 2, the joining surfaces 26, 28 of the upper crown part 12 and the joining surfaces 44, 46 of the lower crown part 14 are preferably contained in respective common planes to allow for easy introduction and removal of a heating coil between the parts as will be described below. However, while the planar arrangement of the joining surface is preferred, the invention is not limited to such an arrangement, and the joining surfaces can be arranged in different planes and have a variety of shapes, so long as the surfaces mate with one another (e.g., the mating surfaces being curved, conical, stepped, or the like).

Prior to welding the lower crown part 14 to the upper crown part 12, the lower crown part 14 is preferably machined, and still more preferably final machined such that a final shape and finish is formed on the pin bores 38, the neck 36, including a cooling gallery recess 48 disposed between the lower inner and outer walls 40, 42 and extending downwardly from the joining surfaces 44, 46 to a bottom wall 50 that extends between and joins the lower ends of the inner and outer walls 40, 42 and is preferably formed as one piece therewith. The lower crown part 14 further includes an integral piston skirt 52 that is fabricated as a single, immovable structure as a part of the lower crown part 14 and is fixed immovably to the pin bosses 34. Inner and outer surfaces 54, 56 of the piston skirt 52 are preferably final machined prior to welding, as are inner and outer faces 58, 60 of the pin bosses 34. The pin bores 38 may further be final machined to include a ring groove 62 used for retaining a wrist pin within the pin bores 38 during operation of the piston 10.

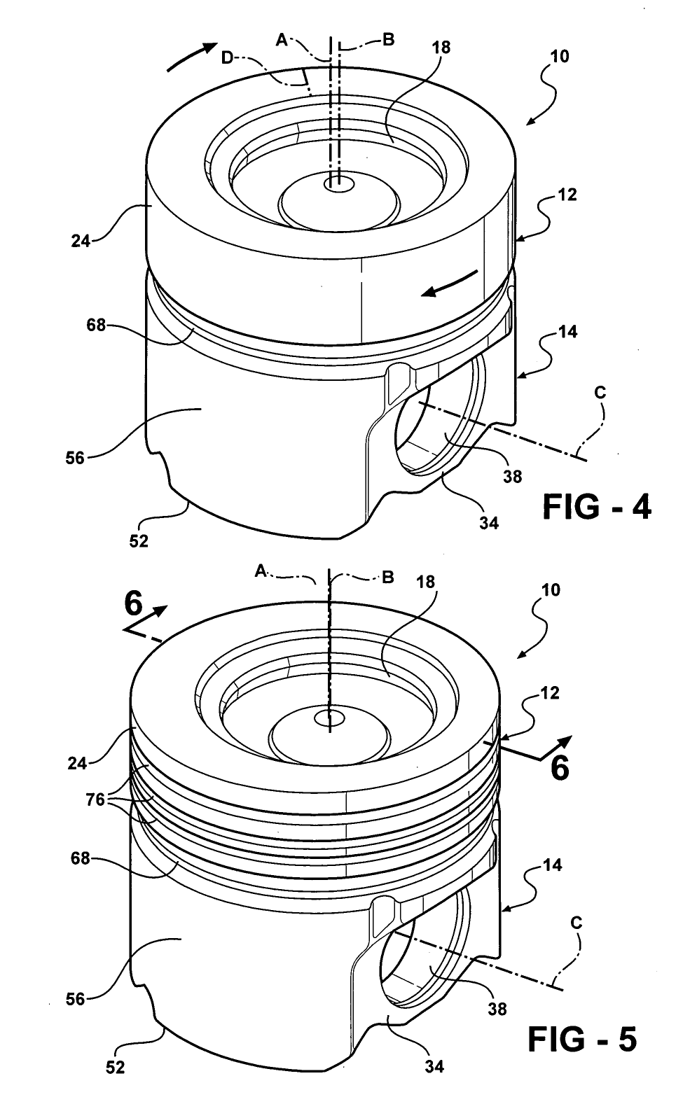

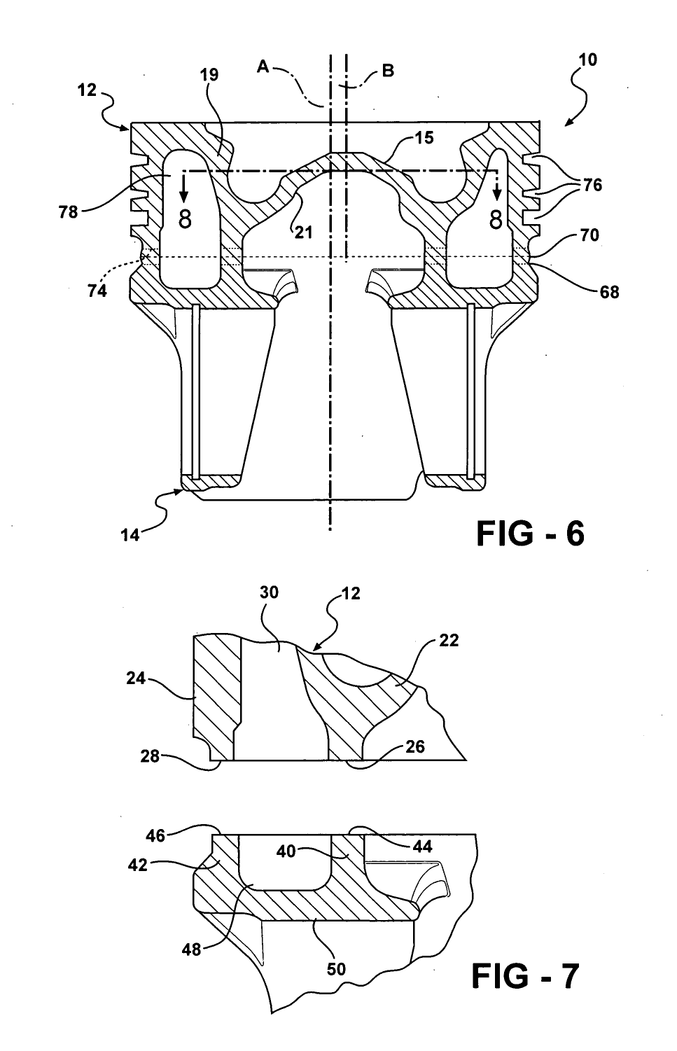

The outer walls 24, 42 of the upper and lower crown parts 12, 14 may be formed adjacent their free ends with a radially reduced upper neck region 64 and lower neck region 64, 66. These regions of the walls are thinner in cross section than the regions of the walls 24, 42 immediately away from the necked regions 64, 66. The joining surfaces 28, 46 are formed at the free ends of the necked regions 64, 66 according to the preferred embodiment, such that when the crown parts 12, 14 are joined as illustrated in FIGS. 4 and 6, an oil drainage groove 68 is formed in the piston sidweall immediately above the pin bosses 34, and a weld joint 70 is formed across the oil drainage groove 68 at the location of the joining surfaces 26, 44 and 28, 46, respectively.

Turning now to further details of the welding operation, FIG. 2 shows the separately formed, pre-machined upper and lower crown parts 12, 14 fixtured with their respective joining surfaces 26, 28 and 44, 46 in axially aligned but spaced relation to one another. A heating coil (not shown), and preferably an induction heating coil 72, is extended into the space between the upper and lower crown parts 12, 14 and the coil 72 is energized to induce heating of the joining surfaces to elevate them to a temperature sufficient to enable the joining surfaces to be bonded metallurgically to one another by means of a induction weld joint. Once heated to a sufficient elevated temperature, the heating coil 72 is quickly removed as illustrated in FIG. 4 and the upper and lower crown parts 12, 14 are moved axially toward one another bringing their respective joining surfaces 26, 44 and 28, 46 into united engagement with one another while at a temperature sufficient for metallurgical bonding. According to the invention, the joining surfaces of both the inner and outer walls are simultaneously heated to the appropriate bonding temperature or temperatures in a single operation by means of the heating coil 72. Preferably, the heating coil 72 comprises an induction heating coil which, when energized, induces a flow of electrons in the inner and outer walls sufficient to cause localized heating of the joining surfaces to an elevated bonding temperature, while the majority of the inner and outer wall material in both the head 12 and base 14 remains largely unaffected by the induction heating (i.e., is not raised to such an elevated temperature, or for that matter to a temperature that would cause a significant change in microstructure of the material). Consequently, the induction heating produces a very controlled heat affected zone (HAZ) 74 which is substantially uniform across the width of the inner and outer walls.

Referring to FIGS. 1 and 4, once the upper and lower crown parts 12, 14 have been heated and brought into contact with one another, the parts 12, 14 are preferably twisted by a relatively small and controlled amount of relative rotation to mix or smear the joining surfaces to achieve a very high integrity metallurgical union or bonding of the upper and lower crown part materials across the weld joint interface 70. This is illustrated in an exaggerated manner with reference to the rotation of line D between the positions shown in FIG. 1 and FIG. 4. The upper and lower crown parts 12, 14 are twisted in the range of a few degrees to less than one revolution, and preferably on the order of about 2-4 degrees. Since the upper crown part 12 includes an asymmetrical feature in the form of combustion bowl 18, it is important that upper crown 12 and lower crown 14 be properly oriented with respect to one another, and particularly with respect to the pin bore axis B in the final piston. Accordingly, the position and fixturing of the crown parts 12, 14 is carefully controlled such that prior to joining the features are misaligned with the axis B by an amount that, following twisting, brings the features into proper orientation with respect to the pin bore axis B.

As shown in FIGS. 5 and 6, following welding, a final machining operation is performed on the piston 10 to provide a series of ring grooves 76 in the ring belt 24. Ring grooves 76 may have any suitable cross-sectional shape and groove depth. The ring grooves 76 are preferably above the oil drainage groove 68 and thus the weld joint 70 is positioned in the outer wall 24, 42 below the lowest of the ring grooves 76.

As a result of welding the upper and lower crown parts 12, 14, a closed oil gallery 78 is formed between the crown parts 12, 14, bounded by the inner and outer walls 22, 40; 24, 42, the upper wall 16, and the bottom wall 50, and the weld joint 70 is exposed to the oil gallery 78. The crown parts 12, 14 may be formed or machined with appropriate oil feed and drainage passages into the oil gallery 78 which may advantageously be formed prior to welding as with the other final machined surfaces described previously.

It will be appreciated that since the joining surfaces 26, 28 and 44, 46 are heated by the heating coil 72 prior to joining the surfaces, rather than heating after the surfaces are joined, the heating of the joining surfaces may be controlled independently to obtain the desired heating of joining surfaces 26, 26 and joining surfaces 44, 46. This can be accomplished by heating the upper and lower joining surfaces independently using different heating coil, or by using a common heating coil but spacing the upper and lower joining surfaces independently to obtain the desired degree of heating. FIG. 7 illustrates a situation in which, because of different geometries, materials, or the like, the joining surfaces of the upper and lower crown parts would not heat in all likelihood uniformly if the coil were positioned an equal distance from each of the sets of joining surfaces. In the illustrated example of FIG. 7, the joining surfaces 26, 28 of the upper crown part 12 would likely require a greater amount or more intense heating than that of the joining surfaces 44, 46 of lower crown part due to the fact that the side walls 40, 42 are joined by side wall 50, and thus the induction coil 72 may be biased or shifted toward the joining surfaces 26, 28 so as to be relatively closer to the upper crown part than to that of the lower crown part. In this way, it can be assured that the mating joining surfaces are properly heated to their required respective bonding temperatures, even when the bonding temperatures of the two parts may be different or one part may require a greater energy input than the other part to attain a given bonding temperature. By shifting the coil 72 toward the part that requires more heating and away from the part that requires less heating, the appropriate control position can be achieved to minimize overheating and prevent underheating of the parts prior to bonding. This ability to control the relative heating of the upper and lower crown parts enables the upper and lower crown parts 12, 14 to be fabricated of different materials having different bonding temperatures, or architectures of the same or different material calling for different heating requirements in order to arrive at the appropriate bonding temperature at the appropriate time for joining with the complementing part.

The parts 12, 14 are preferably fabricated of steel, and more preferably of SAE 4140 steel. The parts 12, 14 are tempered prior to welding to provide a tempered martensite structure having a hardness in the range of 28-34 R_{c}. The hardness of the weld joint at the center is in the range of 35 to 50 R_{c}, and preferably toward the low end of this range. With controlled pre-heating, by the induction coil, of the joining surfaces the hardness of the weld joint can be controlled to within 38-42 R_{c}. The pre-heating effectively “soaks” the joining surfaces and penetrates the heat below the surface. This has the benefit of reducing the “quenching” action of the weld zone material following joining, with the goal of avoiding the formation of untempered martensite at the center, but rather bainite. The 4140 material has the benefit of a suppressed TTT curve that allows for controlled cooling within a reasonable time (i.e., seconds) from the standpoint of manufacturability.

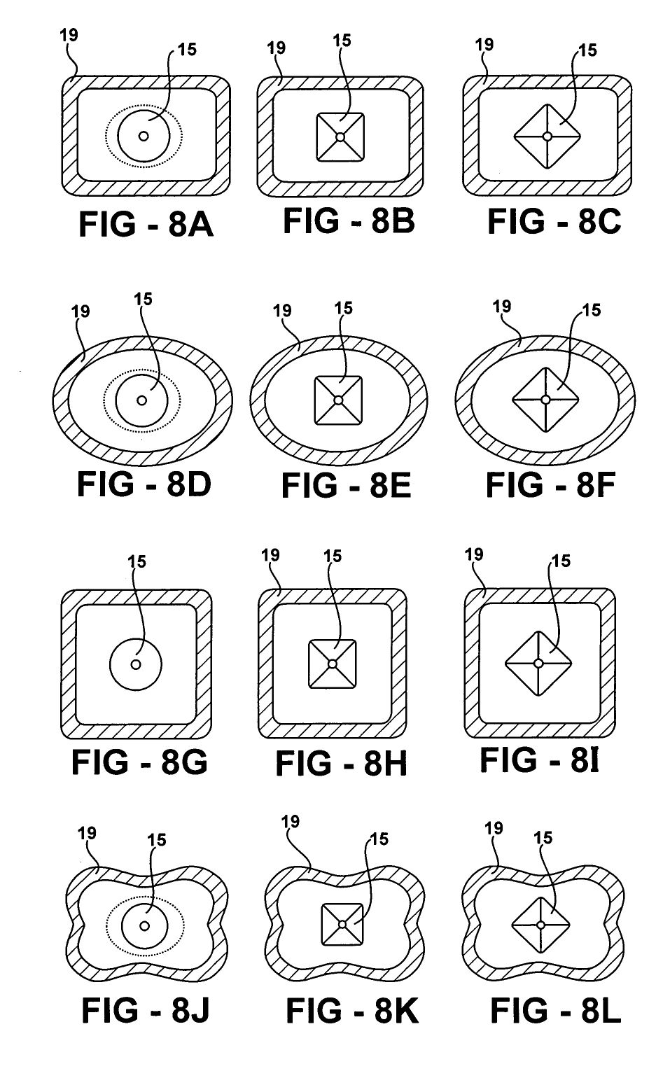

Eccentric combustion bowl 18 may be formed in any desired geometric shape, including simple circular, elliptical and rectangular shapes, or more complex shapes, such as cloverleaves, rosettes and other more complex shapes, as generally illustrated in FIGS. 8A-8L. The shapes may be regular or irregular. It preferably has some form of symmetry about a bowl axis B, but this is not essential to the invention. In addition to the various shapes, the eccentric combustion bowl 18 may have any suitable size, depth and overall internal contour. The center of the combustion bowl 18 may be flat, or may be raised in the center of the bowl or elsewhere as also generally illustrated in FIGS. 1, 2 and 4-6, as well as in FIGS. 8A-8L. It is a particular feature and advantage of the present invention that the sidewalls of the eccentrically located combustion bowl 18, including combustion bowl sidewall 19 and bowl crown sidewall 21, have a substantially uniform sidewall thickness. By substantially uniform, it is meant that there is relatively little variation in the thickness of the combustion bowl sidewalls except at locations where the bowl sidewalls join the other portions of the structure, such as upper wall 16 and annular inner wall 22. This uniformity fosters more uniform cooling around the combustion bowl 18 and avoids localized hotspots in the combustion bowl. It is also an advantage of the invention to combine the eccentrically placed combustion bowl 18 with a substantially uniform sidewall thickness in a design which includes the upper annular outer wall 24 and annular inner wall 22 and lower annular outer wall 42 and inner wall 40 which are concentrically located about the piston axis. The concentric upper walls 22, 24 and lower walls 40, 42 permit the piston 10 to be induction welded and to form a closed oil cooling gallery.

Obviously, many modifications and variations of the present invention are possible in light of the above teachings. It is, therefore, to be understood that within the scope of the appended claims, the invention may be practiced otherwise than as specifically described. The invention is defined by the claims.

What is claimed is:

1. A piston, comprising:
a head portion having a top surface; a bottom surface; a head sidewall and a head longitudinal axis; the top surface having a recessed combustion bowl therein having a bowl axis which is offset from the head axis, a bowl sidewall and a raised bowl crown having a bowl crown sidewall which is located within the bowl about the bowl axis; the bottom surface having a head gallery recess disposed about the combustion bowl and defining a substantially uniform thickness of the bowl sidewall, an undercrown recess disposed proximate the bowl crown portion and defining a substantially uniform thickness of the crown sidewall, a cylindrical outer head joining portion having a substantially uniform thickness which is associated with the piston sidewall and a cylindrical inner head joining portion having a substantially uniform thickness which is associated with the bowl sidewall and the bowl crown sidewall; wherein the outer head joining portion and the inner head joining portion are concentric with the head axis;
a base portion having a top surface, a bottom surface, a base sidewall, and a base longitudinal axis, the top surface having a base gallery recess opposite the head gallery recess and together therewith comprising a closed gallery, an undercrown base recess opposite the undercrown head recess and together therewith comprising an undercrown chamber, a cylindrical outer base joining portion having a substantially uniform thickness which is associated with the base sidewall and a cylindrical inner base joining portion having a substantially uniform thickness, wherein the outer base joining portion and the inner base joining portion are concentric with the base longitudinal axis; and
an outer weld joining the outer head joining portion and the outer base joining portion and an inner weld joining the inner head joining portion and the inner base joining portion.

2. The piston of claim 1, wherein the bowl sidewall has a circular cross-section with reference to a plane perpendicular to the bowl longitudinal axis.

3. The piston of claim 1, wherein the bowl sidewall has a non-circular cross-section with reference to a plane perpendicular to the bowl longitudinal axis.

4. The piston of claim 1, wherein the bowl crown sidewall has a circular cross-section with reference to a plane perpendicular to the bowl longitudinal axis.

5. The piston of claim 1, wherein the bowl crown sidewall has a non-circular cross-section with reference to a plane perpendicular to the bowl longitudinal axis.

6. The piston of claim 1, wherein the thickness of the outer head joining portion and the thickness of the outer base joining portion are the same.

7. The piston of claim 6 wherein the outer head joining portion and the outer base joining portion are necked-down proximate the outer weld.

8. The piston of claim 1, wherein the thickness of the inner head joining portion and the thickness of the inner base joining portion are the same.

9. The piston of claim 1, wherein the inner head joining portion and the inner base joining portion are necked-down proximate the inner weld.

10. The piston of claim 1, wherein the base portion comprises a rigidly attached piston skirt.

11. The piston of claim 1, wherein the base portion comprises a detachably attached piston skirt that is adapted for articulation with respect to the base longitudinal axis.

12. The piston of claim 1, wherein at least one of the head portion and the base portion is fabricated from a casting.

13. The piston of claim 1, wherein at least one of the head portion and the base portion is fabricated from a powder metal.

14. The piston of claim 1, wherein the base portion comprises a pair of opposing pin bosses located in the base sidewall, the pin bosses having a pin boss longitudinal axis.

15. The piston of claim 1, wherein the combustion bowl and the pin boss longitudinal axis have a predetermined angular relationship.

16. The piston of claim 1, wherein the head portion and the base portion are fabricated from a steel alloy.

17. The piston of claim 16, wherein the head portion and the base portion are fabricated from the same steel alloy.

18. A method of making a piston, comprising:
fabricating a generally cylindrical head portion having a top surface; a bottom surface; a head sidewall and a piston head axis; the top surface having a recessed combustion bowl formed therein having a bowl axis which is offset from the piston axis, a bowl sidewall and a raised bowl crown sidewall located within the bowl about the bowl axis; the bottom surface having a head gallery recess disposed about the combustion bowl and defining a substantially uniform thickness of the bowl sidewall, an undercrown recess disposed proximate the bowl crown portion and defining a substantially uniform thickness of the bowl crown sidewall, an outer cylindrical head joining portion having a substantially uniform thickness which is associated with the piston sidewall and an inner cylindrical head joining portion having a substantially uniform thickness which is associated with the bowl sidewall and the bowl crown sidewall; wherein the outer cylindrical head joining portion and the inner cylindrical head joining portion are concentric with the piston;
fabricating a generally cylindrical base portion having a top surface, a bottom surface, a base sidewall, and a base longitudinal axis, the top surface having an outer cylindrical base joining portion having a substantially uniform thickness which is associated with the base sidewall and an inner cylindrical base joining portion having a substantially uniform thickness, wherein the outer cylindrical base joining portion and the inner cylindrical base joining portion are concentric with the base longitudinal axis;
positioning the head portion and the base portion proximate one another with outer head joining portion and outer base joining portion and the inner head joining portion and inner base joining portion in opposing relation to one another and positioned out of contact with one another forming a gap therebetween; and
heating the outer and inner joining portions to an elevated temperature sufficient to promote welding therebetween; and
bringing the outer joining portions and inner joining portions into touching contact with one another, thereby forming outer weld and inner weld, respectively.

19. The method of claim 18 wherein the joining surfaces are heated by a method from the group consisting of friction heating, induction heating and laser heating.

20. The method of claim 19, wherein during the touching contact of the joining portions, at least one of the head portion and base portion is twisted relative to the other.

21. The method of claim 20, wherein the twisting comprises less than 360° of relative rotation.

22. The method of claim 18, wherein fabricating the head portion comprises casting a head portion blank with a precursor of at least one of combustion bowl, gallery recess and undercrown recess.

23. The method of claim 18, wherein fabricating the head portion comprises pressing and sintering of a head portion blank from a powder metal with a precursor of at least one of combustion bowl, gallery recess and undercrown recess.

24. The method of claim 21 wherein the joining surfaces are provided in necked down end regions of the wall sections.

25. The method of claim 18, heating is discontinued prior to bringing the joining surfaces are brought into contact with one another.

26. The method of claim 18, wherein the first portion is formed with a combustion bowl and the second portion is formed with a pair of pin bosses and a piston skirt fixed immovably to the pin bosses.

27. The piston of claim 18, wherein the head portion and the base portion are fabricated from a steel alloy.

28. The piston of claim 25, wherein the head portion and the base portion are fabricated from the same steel alloy.
